(19) United States
(12) Patent Application Publication
(10) Pub. No.: US 2005/0101381 A1
(43) Pub. Date: May 12, 2005

(54) Game system

(75) Inventor: Takanori Hattori, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 10/984,780

(22) Filed: Nov. 10, 2004

(30) Foreign Application Priority Data
Nov. 10, 2003 (JP) 2003-380381

(51) Int. Cl. A63F 13/00

(52) U.S. Cl. 463/29; 463/25; 463/42

(57) ABSTRACT

A game system includes: a plurality of terminal devices, including a reader for reading data from a card and a payout device for paying out a card on which is stored data that differs from the data read from the card by the reader; a controller for receiving sets of game data from the individual terminal devices, and for employing the game data to proceed a game; a commonly used display unit connected to the controller to display a game image in consonance with the proceeding of a game, wherein the reader is capable of reading data from a plurality of types of cards that play different roles in the proceeding of a game, and in accordance with the result of a game, the payout device pays out a card that includes a privilege card that is advantageous for a player during the proceeding of the game.

### CROSS-REFERENCE TO THE RELATED APPLICATION(S)

This application is based upon and claims a priority from prior Japanese Patent Application No. 2003-380381 filed on Nov. 10, 2003, the entire contents of which are incorporated herein by reference.

### BACKGROUND OF THE INVENTION

1. Field of the Invention

The present invention relates to a game system that provides games played using cards, such as game cards and trading cards.

2. Description of the Related Art

The cards that are used for games are, for example, game cards and trading cards. The trading cards that are used for games are not only targets to be collected, but also, since various data are printed on the trading cards, they are employed to play games in which a plurality of players contend. At the end of such a game, contingent upon the result, players exchange or forfeit trading cards.

Game systems have been introduced, and have become widely popular, that provide games played using cards, such as game cards and trading cards. As an example, there is one game system (see, for example, JP-A-2002-153669) that employs a card on which data are stored for the characters in a combat game, and that uses a reader to retrieve the data from the card during the course of a game. As another example, there is a game system (see, for example, JP-A-2002-301264) that permits a player of a game to arrange a plurality of types of cards on a card arrangement panel, and that proceeds the game based on data read from the cards and on how the cards are arranged.

However, for the game systems in JP-A-2002-153669 and JP-A-2002-301264, the data stored on the cards are inherent to those cards and are not changed, and though players at first become attached to the characters appearing in a game, the cards lack unpredictability because the characteristics of the cards are not altered, and after a while, the players lose interest.

### SUMMARY OF THE INVENTION

To resolve the conventional shortcoming, it is one objective of the present invention to provide a game system with which players can engage in acquiring new cards or a collection of cards, and can enjoy a game for an extended period of time without losing interest in the game.

To resolve this objective, the present invention provides the following game system.

According to a first aspect of the invention, there is provided a game system including: a plurality of terminal devices, including a reader for reading data from a card and a payout device for paying out a card on which is stored data that differs from the data read from the card by the reader; a controller for receiving sets of game data from the individual terminal devices, and for employing the game data to proceed a game; a commonly used display unit connected to the controller to display a game image in consonance with proceeding of a game, wherein the reader is capable of reading data from a plurality of types of cards that play different roles in the proceeding of a game, and wherein, in accordance with the result of the game, the payout device pays out a card that includes a privilege card that is advantageous for a player during the proceeding of the game.

According to the first aspect of the invention, since the payout device pays out a card on which there are data that differ from the data read from the card by the reader, the desire of a player to collect cards can be evoked, and the player can enjoy the game for an extended period of time without losing interest. Further, contingent on the result of a game (a condition wherein a desired objective is attained, or a condition wherein a specific event that occurred during the game is cleared), the payout device pays out and provides for a player a card containing privilege data that convey an advantage for the player during the proceeding of the game. Thus, because the opportunity to acquire a new card or to build a card collection is offered, the player will participate more enthusiastically.

### BRIEF DESCRIPTION OF THE DRAWINGS

These and other objects and advantages of the present invention will be more fully apparent from the following detailed description taken in conjunction with the accompanying drawings, in which:

FIG. 1 is a specific perspective view of an example game system according to the present invention;

FIG. 2 is a specific perspective view of a terminal device included in the game system in FIG. 1;

FIG. 3A is a block diagram showing the internal configuration of a main game apparatus provided for the game system in FIG. 1; and FIG. 3B is a block diagram showing the internal configuration of a terminal device provided for the game system 10;

FIG. 4A is a specific perspective view of an example card used for the game system; and FIG. 4B is a partially enlarged cross-sectional view of the card;

FIGS. 5A and 5B are specific front views of example stock cards (game cards); and FIGS. 5C and 5D are specific front views of example stock information cards (player cards);

FIG. 6 is a flowchart showing a sub-routine for the stock information card issuing processing performed by a controller;

FIG. 7A is a diagram showing an example privilege data selection table; and FIG. 7B is a diagram showing the contents of privilege data;

FIG. 8 is a flowchart showing a game proceeding processing routine performed by the controller; and

FIG. 9 is a flowchart showing a sub-routine for the stockholder information card payout processing performed by the controller when a game is ended.

### DETAILED DESCRIPTION OF THE PREFERRED EMBODIMENTS

An explanation will now be given for a game system according to one embodiment of the present invention that provides a simulation game employing stock transactions as the subject matter.

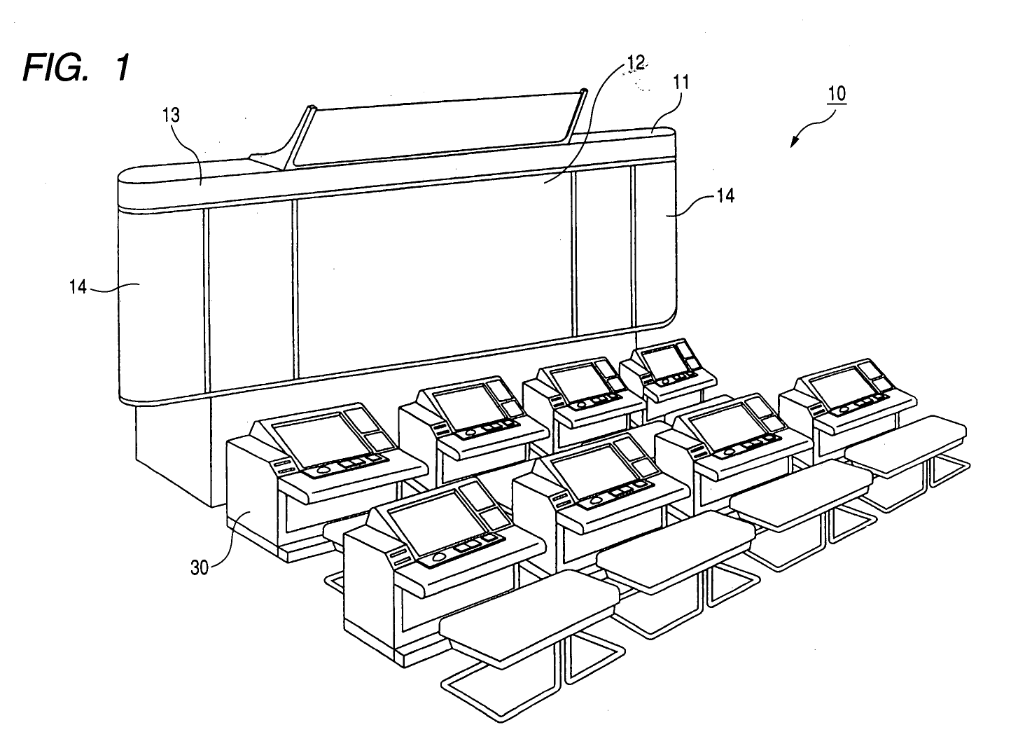

FIG. 1 is a specific perspective view of an example game system according to the embodiment.

A game system 10 includes one main game apparatus 11 and eight terminal devices 30, and permits a maximum of eight players to play a game at the same time.

The main game apparatus 11 includes a controller 20 (not shown) that receives game data from the individual eight terminal devices 30 and that employs the game data to proceed a game.

A common display device 12, provided in the center of the front face of the main game apparatus 11, is connected to the controller 20 to display a game image as the game progresses.

The game images displayed on the common display device 12, in consonance with the proceeding of the game, are: market trend images indicating information required for stock transactions, such as the direction of the market trend, the tendency of stock to fluctuate in the past, and the current market quotations. When a large transaction occurs, information about the transaction is also displayed.

An electric bulletin board 13 is located above the common display device 12. As in an actual stock exchange, real time information for an interesting stock is scrolled and displayed on the electric bulletin board 13. Further, loudspeakers 14 are arranged on the right and left sides of the common display device 12, and in accordance with the game situation, the BGM, sound effects and voices are output by the loudspeakers 14.

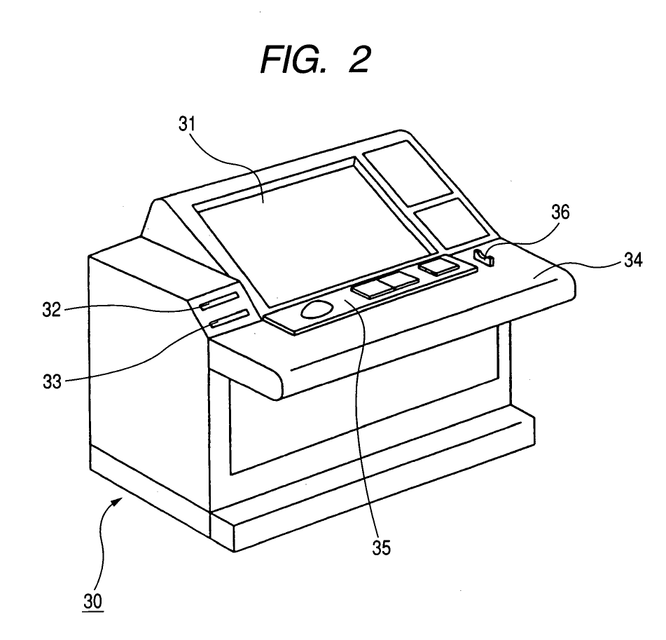

FIG. 2 is a perspective view of one of the terminal devices 30 included in the game system 10 in FIG. 1.

A display panel 31 is provided on the top face of the terminal device 30, an operating table 34 is located in front of the display panel 31, and an operating unit 35, including a plurality of buttons, is arranged on the top face of the operating table 34. When a player manipulates the operating unit 35, various types of images are displayed on the display panel 31 as a consequence of the manipulation, so that the player can follow the game as it proceeds.

A coin slot 36 is formed on the right side of the operating unit 35. When a player inserts a predetermined amount, in coins, into the coin slot 36, the player can receive a stockholder information card that is payoutd and that will be described later. Further, by inserting a predetermined amount, in coins, into the coin slot 36, the player can also play the game for a predetermined period of time.

A stockholder information card (player card) slot 32 and a stock card (game card) slot 33 are formed on the left side of the display panel 31. The stockholder information card is a card including data for a player's personal information (e.g., a name), data concerning the game result obtained by the player, and data concerning the level of the player that is set by the controller 20 in accordance with the result of the game. When the stockholder information card is inserted into the stockholder information card slot 32, playing of the game is initiated, and when the game is terminated, the stockholder information card, including data that reflects the game result, is payout from the stockholder information card slot 32. At this time, in accordance with the game result, a stockholder information card, which includes privilege data advantageous to the player for the proceeding of a game, is also paid out. The privilege data will be described later in detail.

The stock card includes data concerning various information related to the stock of a company, such as the capital stock of the company, the number of employees, the business type, the level of availability of human resources, and management aspects. When during the game the player manipulates the operating unit 35 to enter a buy instruction for the stock of a predetermined group, a stock card for the predetermined group is paid out from the stock card slot 33. On the other hand, when a player inserts a stock card into the stock card slot 33 during the game and manipulates the operating unit 35 to enter a sell instruction for the stock of a pertinent group, the stock for this group can be sold.

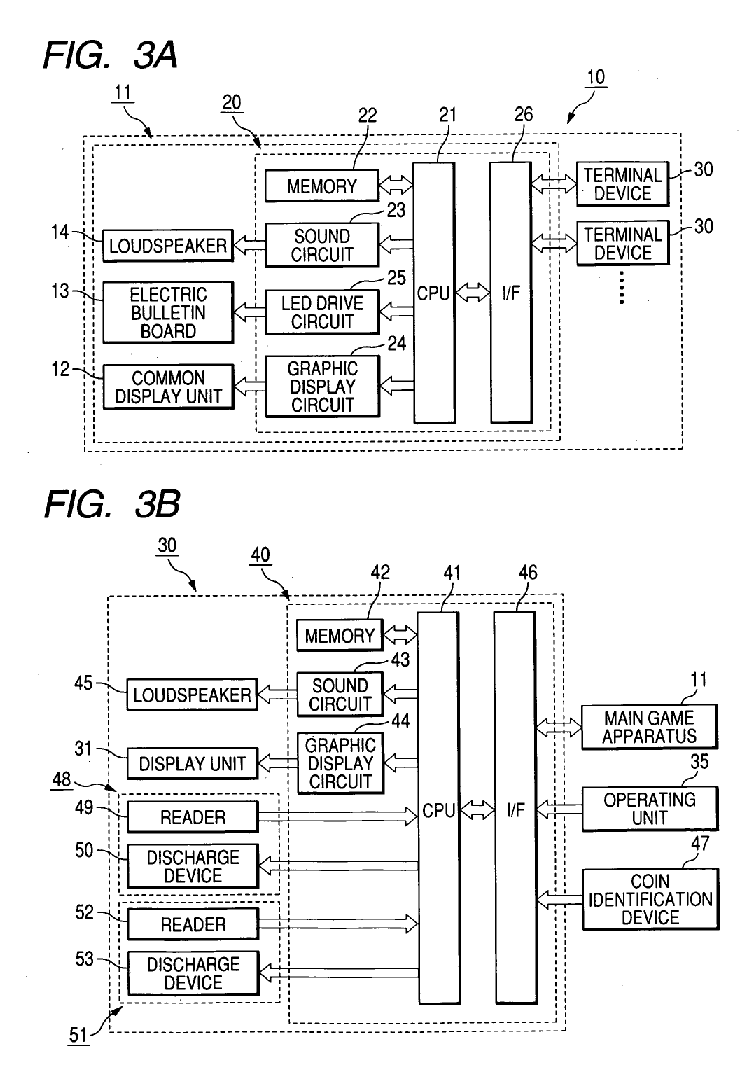

FIG. 3A is a block diagram showing the internal configuration of the main game apparatus 11 of the game system 10 in FIG. 1, and FIG. 3B is a block diagram showing the internal configuration of each terminal device 30 of the game system 10.

As is shown in FIG. 3A, the controller 20 is provided in the main game apparatus 11 of the game system 10. The controller 20 includes: a central processing unit (CPU) 21, a memory 22, a sound circuit 23, a graphic display circuit 24 and an LED drive circuit 25. The CPU 21 is connected to the eight terminal devices 30 through an I/F (interface circuit) 26.

Various image data, for forming game images displayed on the common display device 12, and a control program are stored in the memory 22. The sound circuit 23 is connected to the loudspeakers 14, through which BGM, sound effects and voice are output in consonance with a game image displayed on the common display device 12. The graphic display circuit 24 generates game images in accordance with an instruction transmitted by the CPU 21, and displays the game images on the common display device 12. The LED drive circuit 25 drives an LED constituting the electric bulletin board 13 in accordance with an instruction transmitted by the CPU 21.

As is shown in FIG. 3B, a sub-controller 40 is included in each of the terminal devices 30. The sub-controller 40 includes a CPU 41, a memory 42, a sound circuit 43 and a graphic display circuit 44, and is connected through an I/F 46 to the main game apparatus 11, the operating unit 35 and a coin identification device 47. The CPU 41 receives various data and a program from the main game apparatus 11 through the I/F 46, and also receives command signals entered by the player by manipulating the operating unit 35. The coin identification device 47 detects a coin inserted into the coin slot 36, and transmits a detection signal to the CPU 21. The operation result obtained by the CPU 41 and the manipulation contents at the operating unit 35 are transmitted as game data to the controller 20 of the main game apparatus 11, and the controller 20 employs the game data to proceed the game.

The sound circuit 43 is connected to loudspeakers 45 incorporated in the terminal device 30. The graphic display circuit 44 generates images in accordance with an instructions transmitted by the CPU 21, and displays the images on the display panel 31.

A reader 49 and a payout device 50, which constitute a player card unit 48, are connected to the CPU 41. The player card unit 48 employs the reader 49 to read data from a stockholder information card that has been inserted into the stockholder information card slot 32, and employs the payout device 50 to pay out a stockholder information card from the stockholder information card slot 32. The player card unit 48 includes a card stacker (not shown) wherein a plurality of rewritable cards can be stored, and the payout device 50 includes: a heater (not shown), for printing patterns on the rewritable cards or erasing patterns therefrom; and a writing unit (not shown), for writing data to the rewritable cards.

When the stockholder information card is purchased, the payout device 50 prepares a stockholder information card by printing a predetermined pattern or writing data to a rewritable card stored on the card stacker, and pays out the stockholder information card from the stockholder information card slot 32. Further, when a game is started, the reader 49 reads data from the stockholder information card inserted into the stockholder information card slot 32.

When a game is terminated, the payout device 50 writes to the stockholder information card, which has been inserted into the stockholder information card slot 32, data that reflect the game result. At this time, data concerning the level of the player designated by the controller 20 is also written to the stockholder information card, and in addition, in accordance with the game result, privilege data advantageous to the player for the proceeding of a game is also written to the stockholder information card. Furthermore, depending on the game result, the payout device 50 erases the pattern from the surface of the stockholder information card, prints a new pattern that reflects the game result, and pays out a new stockholder information card.

A reader 52 and a payout device 53, which constitute a game card unit 51, are connected to the CPU 41. The game card unit 51 employs the reader 52 to read data from a stock card inserted into the stock card slot 33, and employs the payout device 53 to discharge a stock card from the stock card slot 33.

As well as the player card unit 48, the game card unit 51 includes a card stacker, and the payout device 53 includes a heater and a writing unit.

When, during a game, a player manipulates the operating unit 35 to enter a buy instruction for the stock of a predetermined group, the payout device 53 prepares a stock card by printing a predetermined pattern on the surface of the rewritable card stored in the card stacker, or by writing data to the rewritable card. Thus, the stock card is paid out from the stock card slot 33.

When during a game the player inserts a stock card for a predetermined group into the stock card slot 33, and manipulates the operating unit 35 to enter a sell instruction for the stock for the group, the reader 52 reads data from the stock card, and the payout device 50 erases the pattern or design and data from the stock card to return the stock card to a rewritable card. The rewritable card is stored in the card stacker.

As is described above, in the game system 10, the reader 49 can read from the stockholder information card (player card), and the reader 52 can read data from the stock card (game card). That is, the readers 49 and 52 of the terminal device 30 can read data from a plurality of types of cards (game cards and player cards), the roles of which differ for the proceeding of a game, and in accordance with the result of a game, the payout device 53 pays out a stockholder information card (player card) including privilege data.

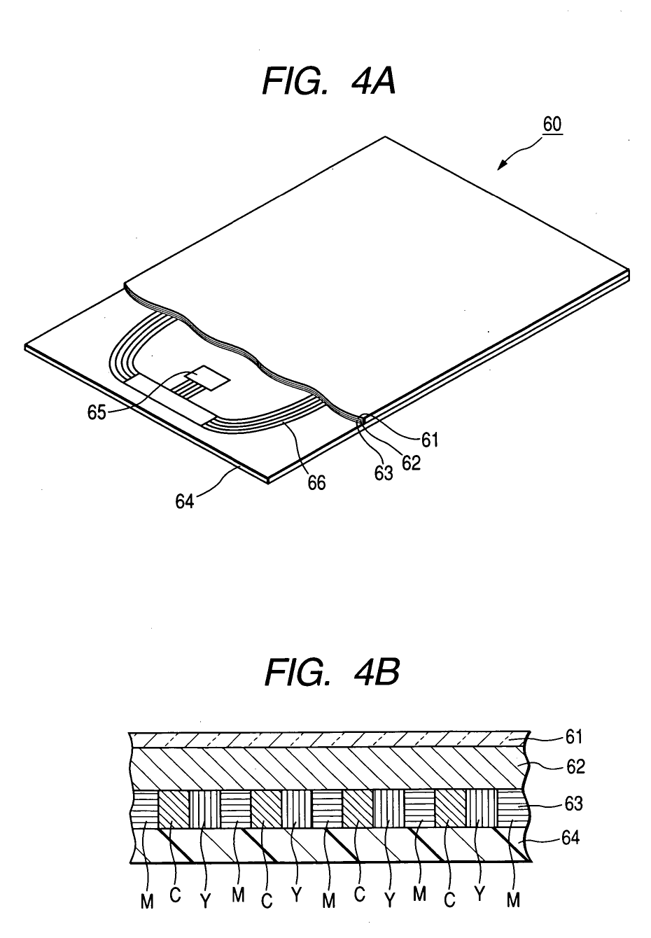

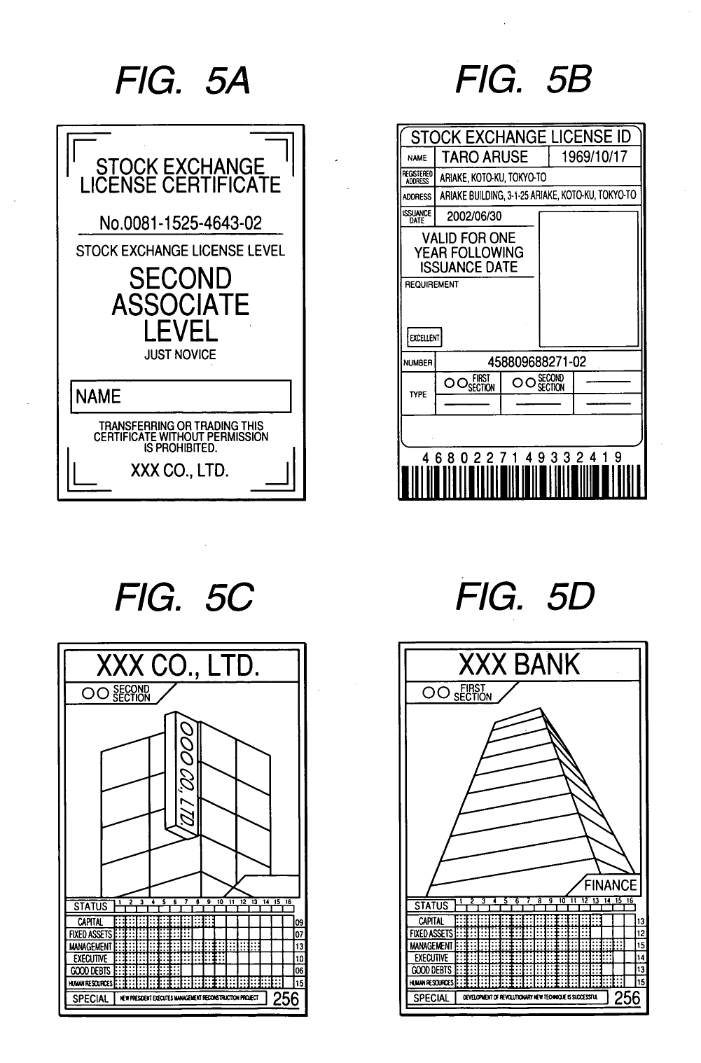

Cards used for the game system 10 will now be described. FIG. 4A is a specific perspective view of an example card 60 used for the game system 10, and FIG. 4B is a partially enlarged cross-sectional view of the card 60. FIGS. 5A and 5B are specific front views of example stock cards (game cards), and FIGS. 5C and 5D are specific front views of example stock information cards (player cards). In FIG. 4A, one part of the card 60 is shown in cross section for convenience sake.

As is shown in FIG. 4A, the card 60 is formed by laminating a color layer 63, a rewritable layer 62 and a transparent protective layer 61, in the named order, on the top face of a rectangular base member 64. A single chip 65 is embedded between the color layer 63 and the base member 64, and an antenna 66 for radio transmission and reception is printed on the base member 64. The single chip 65, which includes a transmission/reception circuit, a control circuit and a memory, receives through the antenna 66 signals from the reader 52 or the payout device 53 of the game card unit 51, and generates power, rewrites data in the memory, or transmits, as a response wave, data stored in the memory. Through this processing, the reading of data from the card 60 and the writing of data to the card 60 can be performed. For the non-contact reading and writing of data, the technique, for example, of the RFID (Radio Frequency Identification) system can be employed, and since this technique is well known and is described in JP-A-8-21875, for example, no further explanation for it will be given.

As is shown in FIG. 4B, the color layer 63 is formed of multiple fine dots, and the rewritable layer 62 is reversibly changed to transparent or opaque by heating it to a specific temperature. When the entire surface of the card 60 is heated at a predetermined temperature by the heater of the payout device 50 or 53, the overall rewritable layer 62 becomes transparent, and the entire surface of the card 60 becomes black, which is a mixture of magenta, cyan and yellow. With this arrangement, the pattern or design printed on the surface of the card 60 can be erased. When the rewritable layer 62 is irradiated with light having a predetermined pattern or design, the rewritable layer 62 selectively becomes opaque due to the heat generated by the light, and a predetermined pattern or design will appear on the surface of the card 60. The rewritable card, and the printing process and the erasing process for the rewritable card, are well known techniques, and since these techniques are described in detail in JP-A-8-80682, for example, no further explanation for them will be given.

In the game system 10, when a player first purchases a stockholder information card, the payout device 49 of the player card unit 48 pays out a stockholder information card shown in FIG. 5A. “Stock Exchange License: Second Associate Level” is printed on the surface of the stockholder information card, and represents the level of the player that is set by the controller 20 at the start of the game. The stockholder information card includes personal information for the player and data for the level of the player. The stockholder information card is not limited to the example shown in FIG. 5A, and may be an imitation of a driver's license, as is shown in FIG. 5B. In this case, a CCD camera need only be provided for the terminal device 30. When a new stockholder information card is to be paid out, the player is photographed by the CCD camera, and the image of the player is printed on the surface of the stockholder information card to be paid out.

When a game using the purchased stockholder information card has been terminated, a stockholder information card is paid out that includes: data for the result of the game, such as the history and the loss or profit on the stock exchange; and data for the level of the player that is determined by the controller in accordance with the result of the game. Further, in the game system 10, in accordance with the result of the game, the discharge card 50 pays out a stock information card including privilege data that is advantageous for the player for the proceeding of the game.

The stock card shown in FIG. 5C is a stock card for a company listed on the second section, and the stock card shown in FIG. 5D is a stock card for a company listed on the first section. The names of stock companies are printed on the upper portions of the cards, the external appearances of the stock companies are printed on the middle of the cards, and various data for the stock companies are printed on the lower portions of the cards. These cards include a variety of information for the pertinent stock companies.

The process performed by the controller 20 of the game system 10 will now be described.

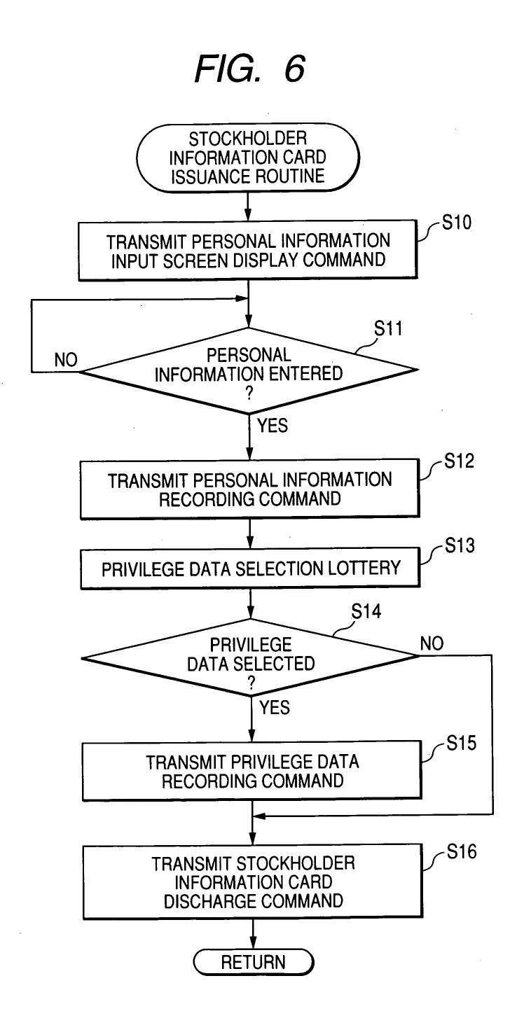

FIG. 6 is a flowchart showing the sub-routine for the stock information card issuing processing performed by the controller 20. When a predetermined amount, in coins, is detected by the coin detector 47 of the terminal device 30, and when the operating unit 35 is manipulated to enter an instruction to issue a stock information card, the controller 20 receives game data from the terminal device 30, and performs the sub-routine in FIG. 6. This sub-routine is performed only for a target terminal device 30.

First, the controller 20 transmits a personal information input screen display command to the target terminal device 30 (step S10). Upon receiving this command, the graphic display circuit 44 of the terminal device 30 generates image data to request the input of the personal information, and displays the image data on the display unit 45. The player then manipulates the operating unit 35 in accordance with the instruction on the screen, and enters personal information.

Then, the controller 20 determines whether the personal information has been entered (step S11). When the controller 20 determines that the personal information has not been entered, the controller 20 returns the processing to step S11, and waits until personal information is entered. When the controller 20 determines that the personal information has been entered, the controller 20 transmits a personal information recording command to the terminal device 30 (step S12). Upon receiving this command, the sub-controller 40 of the terminal device 30 permits the payout device 50 to print a predetermined pattern or design (see, for example, FIG. 5A) on the surface of are writable card stored in the card stacker, or writes personal information as rewritable data to obtain a stockholder information card.

Thereafter, the controller 20 performs a privilege data selection lottery (step S13). For this lottery, the controller 20 determines whether privilege data should be recorded on the stockholder information card, and when the recording of the privilege data is decided, also determines which privilege data should be recorded. This lottery is performed, after the sampling of random numbers, based on sampled random numbers and a privilege data selection table stored in the memory 22.

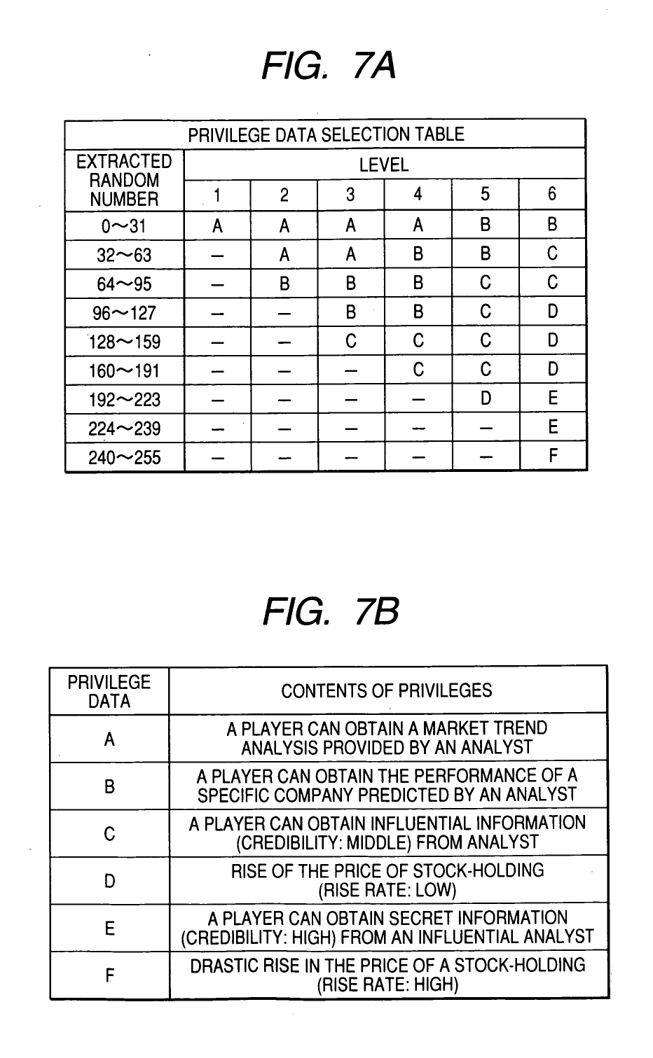

FIG. 7A is a diagram showing an example privilege data selection table, and FIG. 7B is a diagram showing the contents of the privilege data.

As is shown in FIG. 7A, privilege data are entered in the privilege data selection table in accordance with “extracted random numbers”, which are extracted within a range of 0 to 255 obtained by sampling random numbers, and the “levels” of players. In FIG. 7A, “A” to “F” represent the types of privilege data recorded on stockholder information cards, and “-” indicates that privilege data are not recorded on stockholder information cards.

When the sub-routine in FIG. 6 is initiated, the initial value of “1” is set as the level of a player. Therefore, when the “extracted random number” is a value of from 0 to 31, at step S13 in the sub-routine in FIG. 6, privilege data “A” is recorded on the stockholder information card. When the “extracted random number” is a value of from 32 to 255, privilege data is not recorded on the stockholder information card.

When the privilege data is “A”, as is shown in FIG. 7B, the market trend analysis provided by an analyst in a game can be obtained as privilege data. When the privilege data is “B”, the performance predicted by the analyst can be obtained for a specific company in the game designated by the player. When the privilege data is “C”, useful information provided by the analyst can be obtained during the game. When the privilege data is “E”, secret information provided by an influential analyst can be obtained. As is described above, in the game system 10, when a game is played by using a stockholder information card including the privilege data “A”, “B”, “C” or “E”, information advantageous to the player is provided for the terminal device 30 during the game. As a result, the player can purchase a stock whose price will probably rise in the future, or can sell, at an early time, a stock whose price will probably drop, so that the player can proceed the game profitably.

When the privilege data is “D”, an event consisting of a rise in of the price of a stock-holding occurs. When the privilege data is “F”, an event consisting of a drastic rise in the price of a stock-holding occurs. As is described above, in the game system 10, when a game is played using a stockholder information card having the privilege data “D” or “F”, an event advantageous to the player occurs in the game performed by the terminal device 30. As a result, a player can proceed the game profitably.

When the controller 20 has performed the privilege data selection lottery at step S13 of the sub-routine in FIG. 6, the controller 20 determines whether privilege data has been selected (step S14). When the controller 20 determines that privilege data has been selected, the controller 20 transmits a privilege data recording command to the terminal device 30 (step S15). Upon receiving the command, the sub-controller 40 of the terminal device 30 permits the payout device 50 to write the privilege data to the stockholder information card that is generated at step S12.

When the controller has performed the process at step S15, or determines at step S14 that privilege data has not been selected, the controller 20 transmits a stockholder information card discharge command to the terminal device 30 (step S16). Upon receiving the command, the sub-controller 40 of the terminal device 30 permits the payout device 53 to discharge a stockholder information card through the stockholder information card slot 32. The sub-routine is thereafter terminated.

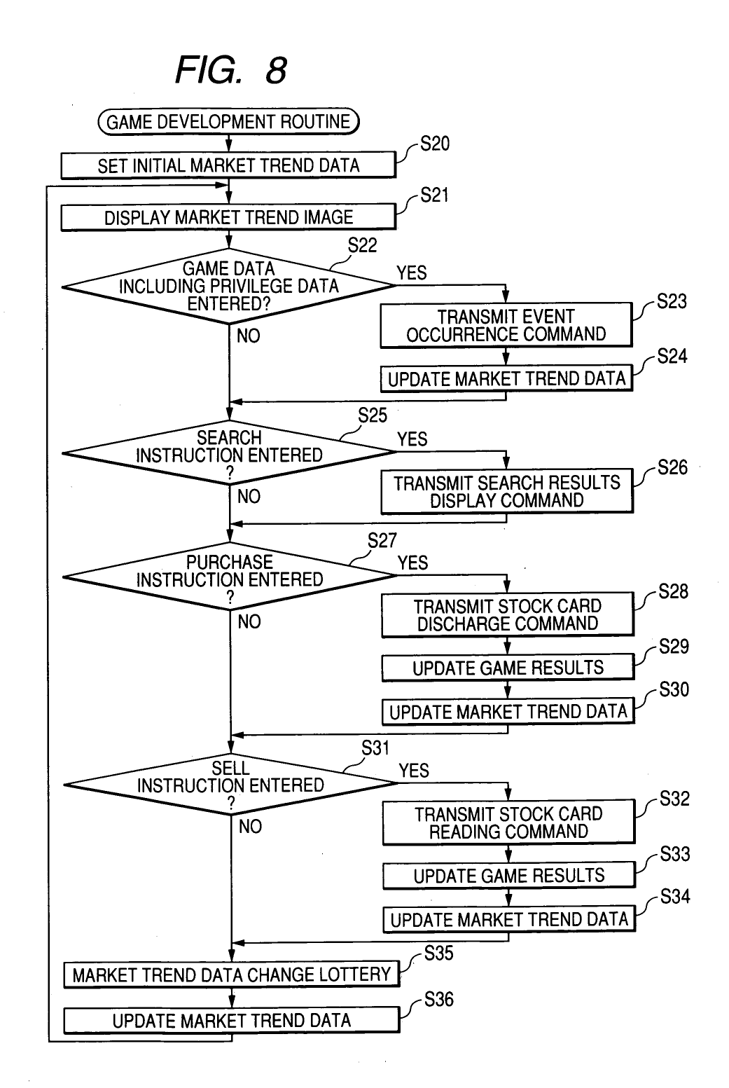

FIG. 8 is a flowchart showing the game progression routine performed by the controller 20. This sub-routine is initiated when the game system 10 is powered on.

When the game system 10 is powered on, first, the controller 20 sets initial market trend data (step S20). The market trend data includes various parameters, such as a stock price, capital, the number of employees, the level of availability of human resources and the management aspect, for stock companies that appear in the game, and parameters for economic conditions, such as business activity. The game is proceeded in accordance with changes in the market trend data.

Next, based on the market trend data, the controller 20 permits the graphic display circuit 24 to display, on the common display unit 12, a game market trend image that represents the fluctuations of the stock prices of the stock companies (step S21). The player examines the market trend image displayed on the common display unit 12 to discuss the purchase or sale of the stocks.

Then, the controller 20 determines whether game data including privilege data has been entered (step S22). When a stockholder information card having privilege data has been inserted into the stockholder information card slot 32 of the terminal device 30, the sub-controller 40 permits the reader 49 to read the privilege data from the stockholder information card and to transmit the game data, including the privilege data, to the main game apparatus 11. In the process at step S22, the controller 20 determines whether the game data, including the privilege data, has been received.

When the controller 20 determines that the game data, including the privilege data, has been entered, the controller 20 transmits an event occurrence command to the terminal device 30, which is a data input source. Upon receiving the command, the sub-controller 40 of the terminal device 30 displays, on the display unit 12, an image concerning the occurrence of a corresponding event and notification of the information for the event.

For example, when the controller 20 determines that game data, including the privilege data “A”, has been entered, the controller 20 transmits a command to the terminal device 30, which is the game data input source, in order to display a market trend analysis provided by an analyst. Upon receiving this command, the sub-controller 40 of the terminal device 30 displays, on the display unit 12, an image concerning the notification of information related to the command, e.g., information indicating that the business activity has recovered and that the stock prices are raised as a whole.

When the controller 20 determines that game data including the privilege data “D” has been entered, the controller 20 transmits a command to the terminal device 30, which is a game data input device, in order to display an image for the rise in the stock price of the group owned by the player. Upon receiving this command, the sub-controller 40 of the terminal device 30 displays, on the display unit 12, an image concerning the occurrence of information related to this event.

When the controller 20 has completed the process at step S23, the controller updates the market trend data so as to reflect either the event that occurred or the contents of the information that was transmitted (step S24).

When the controller determines at step S22 that game data, including privilege data, has not been entered, or performs the process at step S24, the controller 20 determines whether a search instruction has been transmitted by the terminal device 30 (step S25).

When, for example, a player who needs detailed information for a specific stock company manipulates the operating unit 35 to enter the name of the specific stock company, the controller 20 transmits a search instruction to the main game apparatus 11. During the process at step S25, the controller 20 determines whether such a search instruction has been received.

When the controller 20 determines that the search instruction has been entered, the controller 20 transmits a command to the terminal device 30 in order to display information for the stock company to be searched (step S26). Upon receiving the command, the sub-controller 40 of the terminal device 30 permits the graphic display circuit 44 to display, on the display unit 31, information for the stock company obtained by the search.

When the controller 20 determines at step S25 that a search instruction has not been entered, or performs the process at step S26, the controller 20 determines whether an instruction for purchasing a stock card has been received from the terminal device 30 (step S27).

When the controller 20 determines that an instruction for purchasing a stock card has been received, the controller 20 transmits a stock card discharge command to the terminal device 30 (step S28). Upon receiving the command, the sub-controller 40 of the terminal device 30 permits the payout device 53 to print a predetermined pattern or design (see FIG. 5C or 5D) on the surface of a rewritable card stored in the card stacker, or write to the rewritable card various information related to the stock company, and to discharge the thus generated stock card from the stock card slot 33.

Following this, the controller 20 updates the result of the game based on the processing contents at step S27 (step S29). The result of the game relate to the history, or the profit or loss, of the stock transaction of the player, and are stored in the memory 22 for each player. Thereafter, the controller 20 updates the market trend data based on the process contents at step S27 (step S30).

When the controller 20 determines at step S27 that an instruction for purchasing a stock card has not been entered, or performs the process at step S30, the controller 20 determines whether an instruction to sell a stock card has been issued (step S31).

When a stock card is inserted into the stock card slot 33, and the operating unit 35 is manipulated to instruct the sale of the stock card, the instruction for selling the stock card is transmitted by the terminal device 33 to the main game apparatus 11. In the processing at step S31, the controller 20 determines whether such an instruction has been entered.

When the controller 20 determines that the instruction to sell the stock card has been entered, the controller 20 transmits a stock card reading command to the terminal device 30 (step S32). Upon receiving the command, the sub-controller 40 of the terminal device 30 permits the reader 52 to read data from the stock card, and to transmit the data to the main game apparatus 11.

Sequentially, the controller 20 updates the result of the game based on the process contents at step S32 (step S33). Thereafter, the controller 20 updates the market trend data based on the processing contents at step S32 (step S34).

When the controller 20 determines at step S31 that an instruction to sell the stock card has not been entered, or performs the process at step S34, the controller 20 performs a market trend data change lottery (step S35). During the market trend data change lottery, the vertical movements of the various parameters included in the market trend data are determined.

Then, the controller 20 updates the market trend data based on the lottery result obtained at step S35 (step S36). Thereafter, the controller 20 returns the process to step S21. When the process at step S21 is performed, at steps S22 to S36, a market trend image that reflects the updated market trend data is displayed on the common display unit 12.

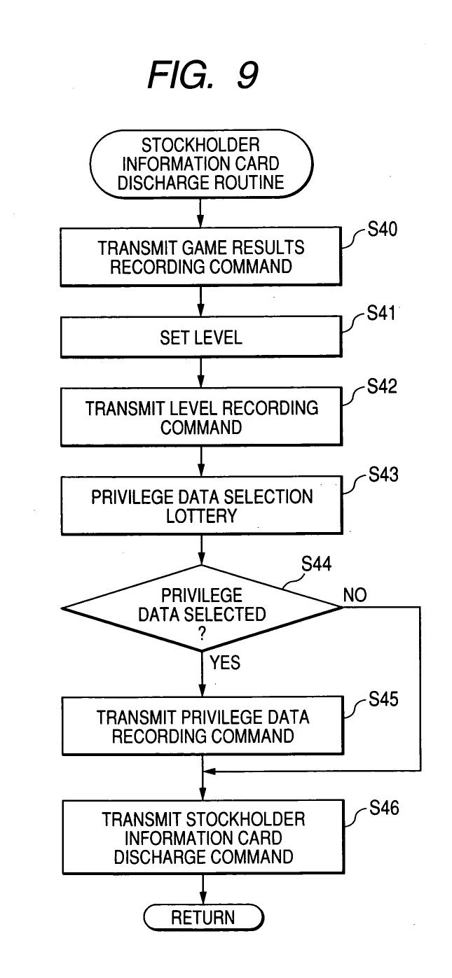

FIG. 9 is a flowchart showing a sub-routine for the stockholder information card discharge processing performed by the controller 20 when the game is ended.

This sub-routine is initiated by the controller 20 when the operating unit 35 of the terminal device 30 is manipulated to enter an instruction to end the game, or when a predetermined period of time has elapsed since the start of the game at the terminal device 30. The sub-routine is performed only for a target terminal device 30.

First, the controller 20 transmits a command to the target terminal device 30 to record the game result on a stockholder information card (step S40). Upon receiving the command, the sub-controller 40 of the terminal device 30 permits the payout device 50 to record the game result on a stockholder information card that has been inserted into the stockholder information card slot 32.

Then, the controller 20 designates the level of the player in accordance with the game result (step S41). The level of the player is raised when a profit exceeds a predetermined value or the profitability exceeds a predetermined value, or is reduced when a profit is less than the predetermined value or the profitability is less than the predetermined value.

Next, the controller 20 transmits a command to the terminal device 30 to record data concerning the level on the stockholder information card (step S42). Upon receiving the command, the sub-controller 40 of the terminal device 30 permits the payout device 50 to record the game result on the stockholder information card that has been inserted into the stockholder information card slot 32.

Sequentially, the controller 20 performs a privilege data selection lottery (step S43). The privilege data selection lottery is the same as the lottery at step S13, i.e., after the sampling of random numbers has been performed, the lottery is performed based on the sampled random numbers and the privilege data selection table stored in the memory 22.

Following this, the controller 20 determines whether privilege data has been selected at step S43 (step S44). When the controller 20 determines that privilege data has been selected, the controller 20 transmits a privilege data recording command to the terminal deice 30 (step S45). Upon receiving the command, the sub-controller 40 of the terminal device 30 permits the payout device 50 to write the privilege data to the stockholder information card.

When the controller 20 performs the process at step S45, or determines at step S44 that privilege data has not been selected, the controller 20 transmits a stockholder information card discharge command to the terminal device 30 (step S46). Upon receiving the command, the sub-controller 40 of the terminal device 30 permits the payout device 50 to discharge a stockholder information card from the stockholder information card slot 32. The sub-routine is thereafter terminated.

As is described above, according to the game system 10, since the payout devices 50 and 53 discharge cards including data different from the data read by the readers 49 and 52, the desires of the players to collect cards can be evoked, and the players can enjoy the game for an extended period of time without losing interest. Further, in accordance with the result of the game (e.g., the result show that the profit exceeds a predetermined value, or that the profitability exceeds the predetermined value), cards including privilege data are paid out and provided for the players. Thus, the players will become more enthusiastic with the acquisition of new cards and the collecting of cards.

It is preferable for the game system 10 of the present invention that a player card (stockholder information card) and a game card (stock card) be included in a plurality of types of cards, the roles of which differ for the proceeding of a game. This is because there is not only the pleasure of collecting game cards but also the pleasure of acquiring player cards on which the game result obtained by the player are reflected thereon, and the desire to acquire new cards or a collection of cards can be increased.

In this invention, a plurality of types of cards that provide different roles for the proceeding of a game are not especially limited, and a plurality of card types that provide different roles in the proceeding of a game may be included among the game cards.

It is also preferable for the invention that, in accordance with the result of the game, the payout device 50 of the game system 10 discharge a player card including privilege data.

This is because the desire of a player to reach a higher level of a player can be evoked, and the enthusiasm for acquiring new cards or a collection of cards can be drastically increased, so that the player can enjoy the game for an extended period of time without losing interest.

According to the present invention, it is preferable that, upon receiving game data relevant to privilege data (D or F), the controller 20 of the game system 10 develop the game so that an event (a rise or a drastic rise in the price of the stock-holding) profitable to a player occurs in the game operated by the terminal device 30, which is the game data transmission source. It is also preferable that, upon receiving game data relevant to privilege data (A, B, C or E), the controller 20 proceed the game so that information, such as information from an analyst, advantageous to a player is transmitted, during the game, to the terminal device 30, which is the game data transmission source. This is because the interest in or attention given to the game and the desire to acquire new cards or a collection of cards can be increased as a combined effect, so that the player can enjoy the game for an extended period of time without losing the interest.

According to the invention, unlike in the game system 10, a card including privilege data paid out from the payout device need not always be a player card (stockholder information card). For example, a game card (stock card) including privilege data may be paid out by the payout device.

In the game system 10, in accordance with the result of the game, the payout device 50 pays out one card including privilege data. However, for the invention, it is preferable that, in accordance with the result of the game, the payout device 50 discharge a plurality of cards including privilege data. When a plurality of cards include privilege data, the desire to acquire new cards or to collection cards can be even more increased. A card that is extremely rarely paid out may be designated as a premium card in advance. Since a specific card has a scarcity value, the desire to acquire new cards or a collection of cards can be increased.

The game system 10 has employed a rewritable card for which non-contact data reading and the repetitive writing and printing and erasing of a pattern on the surface are enabled. However, a card applicable for the game system of the invention is not especially limited, and a card having magnetic stripes or a contact IC card may also be employed. Further, a card may be employed wherein a pattern for data is formed so as to be optically identified.

In the game system, each time a card is paid out, the terminal device 30 has printed a pattern or has written data to the surface of the card. However, for the present invention, a plurality of cards, on which inherent data are written and patterns are printed, may be stored in the terminal device, and one of these cards may be selected and paid out each time.

According to the invention, since the player employs a player card, which contains data concerning the level of the player, and a game card, which is paid out as a result of a game and provided for the player during the game, the player not only has the pleasure of collecting a game card, but also the pleasure of obtaining a player card that reflects the result of the his or her game. Thus, the desire of the player to acquire a new card or to build a card collection can be increased.

According to the invention, a player card including privilege data is paid out contingent on the result of a game. And when, for example, the level of a player in a game has increased as a result of playing the game, the paid out card includes data for the increased level as well as privilege data. This player card is valued not only as a collection target, but also a value for the proceeding of a game, such that the player advantageously plays the game by using the privilege data. The player card also has a value in that the player can show his or her game record to others and can feel superior. Therefore, the eagerness of a player to raise his or her level in the game can be evoked, and the desire to acquire a new card or a collection of cards can be considerably increased. As a result, a player can play the game for an extended period of time without losing interest.

According to the invention, since a plurality of cards including privilege data are paid out contingent on the result of the game, the desire of a player to acquire a new card or to build a card collection can be increased.

According to the invention, when a game provided by the game system is related, for example, to stock transactions, and is played by using a card including privilege data, an event advantageous to a player, such as a dramatic rise in the price of a stock owned by the player, occurs. Therefore, as a combined effect, both interest in or attention given to the game and the desire to acquire a new card or a collection of cards can be increased, and the player can enjoy the game for an extended period of time without losing interest.

According to the invention, when a game provided by the game system is related, for example, to stock transactions, and is played by using a card including privilege data, information advantageous to a player, such as relevant information available from an analyst or information related to the predicted performance of a company, is transmitted to the player. Thus, as a combined effect, both the interest in or the attention given to the game and the desire to acquire a new card or a collection of cards can be increased, and the player can enjoy the game for an extended period of time without losing interest.

According to the invention, a game system can be provided that can keep a player to desirous of acquiring a new card or a collection of cards, and will permit the player to enjoy a game for an extended period of time without losing interest.

1. A game system comprising:
a plurality of terminal devices, including a reader for reading first data from a card and a payout device for paying out a card on which is stored second data that differs from the first data read from the card by the reader;
a controller for receiving sets of game data from the individual terminal devices, and for employing the game data to proceed a game;
a common display unit connected to the controller to display a game image in consonance with proceeding of a game, wherein:
the reader reads the first data from a plurality of types of the cards that play different roles in the proceeding of a game; and
in accordance with the result of the game, the payout device pays out a card that includes a privilege card that is advantageous for a player during the proceeding of the game.

2. The game system according to claim 1, wherein
the plurality of types of cards that play different roles in the proceeding of the game include:
a player card on which data concerning a level of the player that is set by the controller contingent on the result of a game; and
a game card that, as a result of the game, is paid out during the game by the payout device and is provided for the player.

3. The game system according to claim 2, wherein
contingent on the result of the game, the payout device pays out the privilege card.

4. The game system according to claim 1, wherein
contingent on the result of the game, the payout device pays out a plurality of the privilege cards.

5. The game system according to claim 1, wherein
upon receiving the game data relevant to privilege data in the privilege card, the controller proceeds the game so as to transmit advantageous information to a player who is playing the game with the terminal device from which the game data is transmitted.

6. The game system according to claim 1, wherein
upon receiving the game data relevant to privilege data in the privilege card, the controller proceeds the game so as to cause an advantageous event to a player who is playing the game with the terminal device from which the game data is transmitted.

7. The game system according to claim 1, wherein:
the controller performs a privilege data selection lottery, the controller determines whether privilege data to be recorded on the card, and when recording of the privilege data is determined, the controller determines which set of the privilege data to be recorded; and
the privilege data selection lottery is performed after sampling of random numbers and a privilege data selection table.
